(19) United States
(12) Patent Application Publication
(10) Pub. No.: US 2011/0131215 A1
(43) Pub. Date: Jun. 2, 2011

(54) PROCESS APPARATUS, DATA SCHEDULING METHOD, AND COMPUTER READABLE MEDIUM THEREOF FOR A DATA SCHEDULE

(75) Inventors: Chung-Ming HUANG, Kaohsiung City (TW); Shih-Yang LIN, Changhua County (TW); Chih-Hsun CHOU, Tucheng City (TW)

(73) Assignee: INSTITUTE FOR INFORMATION INDUSTRY, Taipei (TW)

(21) Appl. No.: 12/630,473

(22) Filed: Dec. 3, 2009

(30) Foreign Application Priority Data
Nov. 27, 2009 (TW) 098140569

(51) Int. Cl. G06F 17/30

(52) U.S. Cl. 707/748; 707/E17.122

(57) ABSTRACT

A process apparatus, a data scheduling method, and a computer readable medium thereof for a data schedule are provided. The process apparatus comprises a storage, a receiving interface, and a microprocessor. The microprocessor is respectively electrically connected to the storage and the receiving interface. The storage is configured to store a data scheduling structure which is constructed of a plurality of data items in an execution sequence. The receiving interface receives an input data item. The microprocessor retrieves at least one relevant data item from the data items according to the correlation information of the input data item. The microprocessor further performs a weight calculation according to the at least one relevant data item and the input data item, so as to generate at least one weight calculation result. The microprocessor further inserts the input data item into the data scheduling structure according to the at least one weight calculation result, so as to form an updated data scheduling structure.

This application claims priority to Taiwan Patent Application No. 098140569 filed on Nov. 27, 2009.

### CROSS-REFERENCES TO RELATED APPLICATIONS

Not applicable.

### BACKGROUND OF THE INVENTION

1. Field of the Invention

The present invention relates to a process apparatus, a data scheduling method and a computer readable medium thereof. Specifically, the present invention relates to a process apparatus, a data scheduling method and a computer readable medium thereof for updating a data scheduling structure.

2. Descriptions of the Related Art

In recent years, as wireless communication technologies become matured rapidly, various wireless mobile communication apparatuses such as cell phones, personal digital assistants (PDAs), notebook computers and the like have found wide application in people's daily life. Accordingly, data quantity to be processed by wireless communication systems deployed by wireless communication operators also experiences a rapid increase. In general, a wireless communication system processes data it receives according to a data schedule so as to optimize performance of the wireless communication system. Data scheduling schemes conventionally used include normal scheduling, priority scheduling, batch scheduling, and so on.

Taking the conventional priority scheduling as an example, after receiving a requested transmission data item from a user, a server end of a wireless communication system will perform a priority weight calculation on the data item and each data item currently existing in the server end according to an arrival time, a wait time, a request rate and the like parameters, and re-order all the data items according to the weight values obtained through the weight calculation in order to decide a sequence in which the data items are to be transmitted by the server end.

However, in such a priority scheduling process, weight values of all data items already existing in the server must be re-calculated each time a new data item is received, which consumes much calculation cost and time. Moreover, the conventional priority scheduling fails to take the correlation among data items into account, which causes degradation in the scheduling efficiency and possibly causing mistakes in the scheduling. To say the least, even if the conventional priority scheduling takes the correlation among data items into account, it usually still needs to schedule all data items with respect to each relevant data item individually; albeit of improvement in accuracy of the scheduling, this further adds to the computational burden, so the effect of improving the scheduling efficiency is still very limited.

In summary, although multiple of scheduling methods have been provided in the prior art, none of them can make an appropriate compromise between accuracy and computational cost of the scheduling. Therefore, it is highly desirable in the art to provide a scheduling method that can make a compromise between accuracy and computational cost of the scheduling.

### SUMMARY OF THE INVENTION

An objective of the present invention is to provide a process apparatus for implementing a data scheduling method. The process apparatus comprises a storage, a receiving interface and a microprocessor. The storage is configured to store a data scheduling structure comprised of a plurality of data items in an execution sequence. The receiving interface is configured to receive an input data item. The microprocessor is electrically connected to the storage and the receiving interface respectively and configured to retrieve a relevant data item from the data items according to the input data item; Next, perform a weight calculation according to the relevant data item and the input data item to generate a weight calculation result; and insert the input data item into the data scheduling structure according to the weight calculation result to generate an updated data scheduling structure.

Another objective of the present invention is to provide a data scheduling method which is implemented by a process apparatus. The process apparatus comprises a storage, a receiving interface and a microprocessor. The storage is configured to store a data scheduling structure comprised of a plurality of data items in an execution sequence. The receiving interface is configured to receive an input item. The microprocessor is electrically connected to the storage and the receiving interface respectively. The data scheduling method comprises the following steps of: (A) enabling the microprocessor to retrieve a relevant data item from the plurality of data items according to the input data item; (B) enabling the microprocessor to perform a weight calculation according to the relevant data item and the input data item to generate a weight calculation result; and (C) enabling the microprocessor to insert the input data item into the data scheduling structure according to the weight calculation result to generate an updated data scheduling structure.

Yet a further objective of the present invention is to provide a computer readable medium, which stores a program of a data scheduling method for a process apparatus. The process apparatus comprises a storage, a receiving interface and a microprocessor. The storage is configured to store a data scheduling structure comprised of a plurality of data items in an execution sequence. The receiving interface is configured to receive an input item. The microprocessor is electrically connected to the storage and the receiving interface respectively. When being loaded into the process apparatus, the program executes: a code A for enabling the microprocessor to retrieve a relevant data item from the data items according to the input data item; a code B for enabling the microprocessor to perform a weight calculation according to the relevant data item and the input data item to generate a weight calculation result; and a code C for enabling the microprocessor to insert the input data item into the data scheduling structure according to the weight calculation result to generate an updated data scheduling structure.

In summary, according to the present invention, a relevant data item is retrieved from data items of the data scheduling structure according to the input data item, then a weight calculation is performed on the input data item and the relevant data item to generate a weight calculation result, and the weight calculation result is used to update the original data scheduling structure. In other words, by virtue of correlation between data items, the present invention re-performs the weight calculation only on a portion of the data items of the data scheduling structure and updates the original data scheduling structure. This reduces the computational cost needed for the data scheduling and improves the scheduling accuracy, thereby overcoming the drawbacks of the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a process apparatus for data scheduling according to a first embodiment of the present invention; and

FIGS. 2A-2D are a flowchart of a data scheduling method according to a second embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

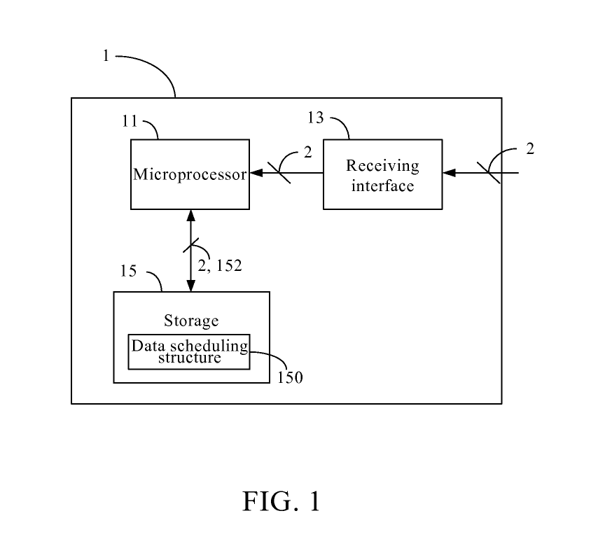

A first embodiment of the present invention is shown in FIG. 1, which is a schematic view of a process apparatus 1 adapted to implement a data scheduling method. The process apparatus 1 comprises a microprocessor 11, a receiving interface 13 and a storage 15. The microprocessor 11 is electrically connected to the storage 15 and the receiving interface 13 respectively. The storage 15 stores a data scheduling structure 150. In this embodiment, the process apparatus 1 may be a server for use in a wireless network. In other embodiments, the process apparatus 1 may also be utilized in other fields which need the data scheduling (i e the task scheduling of the central processor unit . . . etc) upon the practical demands, thus it does not limit the application scope of the present invention. Hereinbelow, how the process apparatus 1 implements the data scheduling method will be described.

To explain how the process apparatus 1 implements the data scheduling method more clearly, the data scheduling structure 150 stored in the storage 15 will be defined at first. The data scheduling structure 150 is comprised of a plurality of data items in an execution order. More specifically, in this embodiment, the data scheduling structure 150 may be a heap tree, in which individual nodes of the heap tree exist in a sequence. Data items of the data scheduling structure 150 may be viewed as nodes of the heap tree and exist in the heap tree in the aforesaid execution sequence. It should be noted that, rather than being limited thereto, the data scheduling structure 150 may also be of other sequence structures depending on practical applications.

When an input data item 2 is received by the receiving interface 13 of the process apparatus 1, the microprocessor 11 determines whether a data scheduling structure is stored in the storage 15. If there isn't, the microprocessor 11 stores the input data item 2 into the storage 15 directly to form a data scheduling structure. However, as can be known from the above description, the storage 15 already has the data scheduling structure 150 stored therein; hence, thus the microprocessor 11 determines that the storage 15 has already stored a data scheduling structure 150 therein, retrieves a relevant data item 152 from the plurality of data items of the data scheduling structure 150 according to the input data item 2, and then performs a weight calculation according to the relevant data item 152 and the input data item 2 to generate a weight calculation result. Finally, the microprocessor 11 inserts the input data item 2 into the data scheduling structure 150 according to the weight calculation result to form and output an updated data scheduling structure.

In more detail, the received input data item 2 and each data item of the data scheduling structure 150 comprises a parameter set and correlation information. After it is determined that the storage 15 already has a data scheduling structure 150 stored therein, the microprocessor 11 retrieves a data item 152 relevant to the correlation information of the input data item 2 from the plurality of data items stored in the data scheduling structure 150 according to the correlation information of the input data item 2, and then performs a weight calculation according to the input data item 2 and the parameter set of the relevant data item 152 to generate the weight calculation result.

It should be noted that, in other embodiments, the correlation information of the input data item 2 may be relative to a plurality of the relevant data items. The microprocessor 11 may also perform the weight calculation according to the parameter sets of the relevant data items and the input data item 2 to generate a plurality of weight calculation results. The number of the weight calculation results is increased or decreased upon the number of data items. The microprocessor 11 may further insert the input data item 2 to the data scheduling structure 150 according to all the weight calculation results to form and output an updated data scheduling structure.

Additionally in this embodiment, the parameter set may comprise an arrival time parameter, a wait time parameter, a distance parameter, a velocity parameter or a combination thereof. In other embodiments, rather than being limited thereto, the parameter set may further comprise other parameters that can be used in the weight calculation. The aforesaid correlation information includes two portions: one is the content of the data item itself, and the other is other factors. The content of the data item itself means that the content of the data item itself has other data items that are indicated to be affected, and the other factors refer to results that may be obtained by performing an operation on the data item through events, methods or procedures.

Taking a case in which data scheduling is used for early warning of vehicle collision as an example, the process apparatus 1 may be a server that is configured to relay data items transmitted by all vehicles within signal coverage thereof. Data items stored in the data scheduling structure 150 are transmitted by the individual vehicles, and the parameter set of each data item comprises an arrival time parameter, a wait time parameter, a distance parameter and a velocity parameter.

On the other hand, the correlation information of the data items is configured to record relevance among the vehicles. When a vehicle A and a vehicle B are both located at a corner of a road, there is a higher probability that they will collide with each other. Because data scheduling is used for early warning of vehicle collision, the correlation information of the data item transmitted by the vehicle A records that it is relevant to the data item transmitted by the vehicle B, while the correlation information of the data item transmitted by the vehicle B records that it is relevant to the data item transmitted by the vehicle A.

After the receiving interface of the process apparatus 1 receives a data item transmitted by the vehicle A, the microprocessor 11 will firstly determine that the storage 15 already has the data scheduling structure 150 stored therein and, according to the correlation information of the data item transmitted by the vehicle A, retrieve from the data scheduling structure 150 all data items transmitted by the vehicle A and vehicle B, which are exactly the relevant data items described above. Then, the microprocessor 11 performs a weight calculation according to the parameter set of the currently received data item and the parameter set of the relevant data items to generate a weight calculation result, and inserts the data item currently received into the data scheduling structure 150 according to the weight calculation result to generate an updated data scheduling structure.

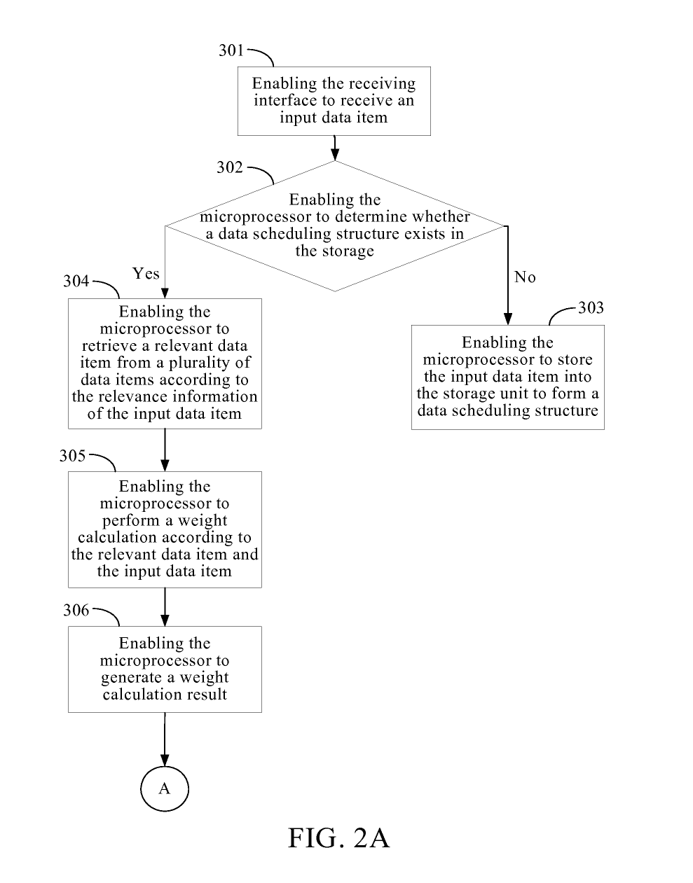

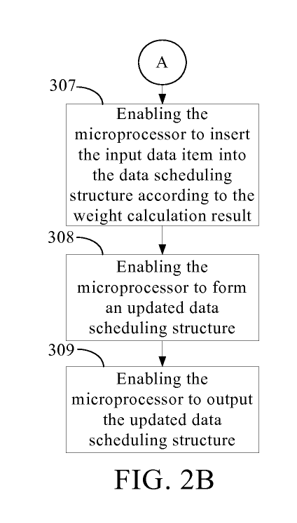

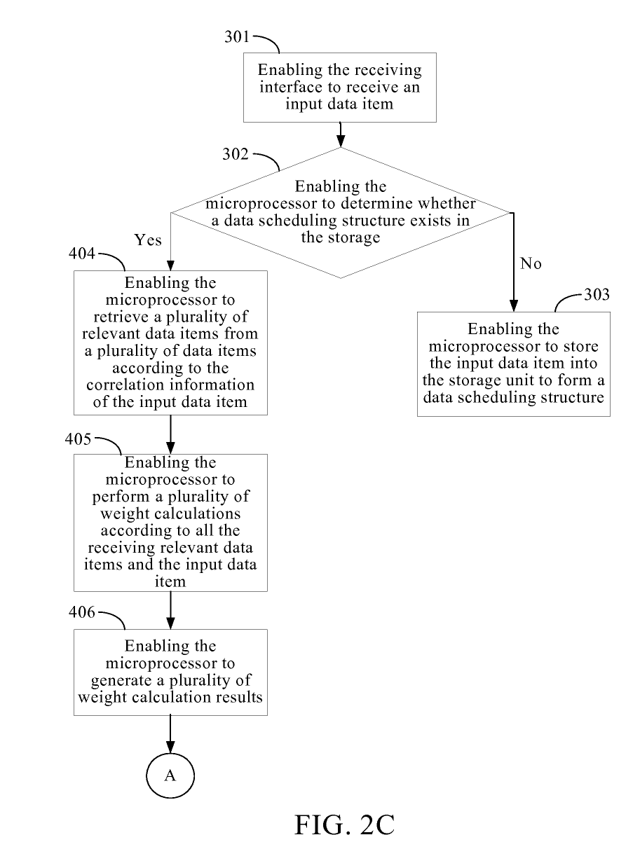

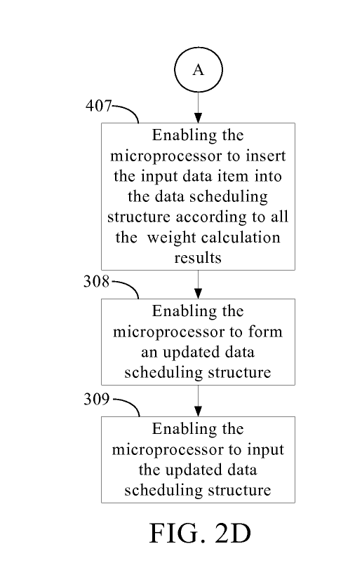

A second embodiment of the present invention is shown in FIGS. 2A-2B, which are a flowchart of a data scheduling method that is implemented by the process apparatus of the first embodiment. The process apparatus comprises a storage, a receiving interface and a microprocessor. The microprocessor is electrically connected to the storage and the receiving interface respectively. The storage is configured to store a data scheduling structure. The data scheduling structure is comprised of a plurality of data items in an execution order, and the receiving interface is configured to receive an input data item.

More specifically, the data scheduling method described in the second embodiment may be implemented by a program stored in a computer readable medium. When an input data item is loaded into the computer readable medium via a computer and a plurality of codes contained in the computer readable medium is executed, the data scheduling method of the second embodiment can be accomplished. This computer readable medium may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The data scheduling method comprises the following steps. Referring firstly to FIG. 2A, step 301 is executed to enable the receiving interface to receive an input data item. Then, step 302 is executed to enable the microprocessor to determine whether a data scheduling structure has already been stored in the storage. If not, step 303 is executed to enable the microprocessor to store the input data item into the storage to form a data scheduling structure.

Specifically, in this embodiment, the data scheduling structure may be a heap tree, in which individual nodes of the heap tree exist in a sequence. Data items of the data scheduling structure may be viewed as nodes of the heap tree and exist in the heap tree in the aforesaid execution sequence. It should be noted that, rather than being limited thereto, the data scheduling structure may also be of other sequence structures depending on practical applications.

Referring back to FIG. 2A, if the microprocessor determines that a data scheduling structure has already been stored in the storage, step 304 is executed to enable the microprocessor to retrieve a relevant data item from a plurality of data items according to the correlation information of the input data item, and then step 305 is executed to enable the microprocessor to perform a weight calculation according to the relevant data item and the input data item. More specifically, both the relevant data item and the input data item have a parameter set, which may comprise an arrival time parameter, a wait time parameter, a distance parameter, a velocity parameter or a combination thereof. The weight calculation is performed by the microprocessor according to the relevant data item and the parameter set of the relevant data item.

Next, step 306 is executed to enable the microprocessor to generate a weight calculation result after completion of the weight calculation, and step 307 is executed to enable the microprocessor to insert the input data item into the data scheduling structure according to the weight calculation result. Next, step 308 is executed to enable the microprocessor to form an updated data scheduling structure by inserting the input data item into the data scheduling structure. Finally, step 309 is executed to enable the microprocessor to output the updated data scheduling structure.

It should be noted that, in another implement aspect of the present embodiment, the correlation information of the input data item 2 may be relative to a plurality of the relevant data items. The flowcharts of another implement aspect may be illustrated in FIG. 2C and FIG. 2D. First, step 301 is executed to enable the receiving interface to receive an input data item. Then, step 302 is executed to enable the microprocessor to determine whether the storage stores a data scheduling structure. If not, step 303 is executed to enable the microprocessor to store the input data item into the storage unit to form a data scheduling structure.

If the microprocessor determines that the storage has stored a data scheduling structure. Then, step 404 is executed to enable the microprocessor to retrieve a plurality of relevant data items from a plurality of data items according to the correlation information of the input data item. Next, the step 405 is executed to enable the microprocessor to perform the multiple weight calculation according to all of the retrieving relevant data items and the input data item. More particularly, each relevant data item and the input data item have a plurality of parameter sets respectively, which may comprise an arrival time parameter, a wait time parameter, a distance parameter, a velocity parameter or a combination thereof. The microprocessor performs the multiple weight calculations according to the relevant data items and all the parameter sets of which.

Next, step 406 is executed to enable the microprocessor to generate a plurality of weight calculation results after completion of the weight calculations. Step 407 is executed to enable the microprocessor to insert the input data item into the data scheduling structure according to all the weight calculation results. Then, step 308 is executed to enable the microprocessor to form an updated data scheduling structure by inserting the input data item into the data scheduling structure. Finally, step 309 is executed to enable the microprocessor to output the updated data scheduling structure.

The aforesaid correlation information includes two portions: one is the content of the data item itself, and the other is other factors. The content of the data item itself means that the content of the data item itself has other data items that are indicated to be affected, and the other factors refer to results that may be obtained by performing an operation on the data item through events, methods or procedures.

Taking a case in which data scheduling is used for early warning of vehicle collision as an example, the process apparatus may be a server that is configured to relay data items transmitted by all vehicles within signal coverage thereof. Data items stored in the data scheduling structure are transmitted by the individual vehicles, and the parameter set of each data item comprises an arrival time parameter, a wait time parameter, a distance parameter and a velocity parameter.

On the other hand, the correlation information of the data items is configured to record relevance among the vehicles. When a vehicle A and a vehicle B are both located at a corner of a road, there is a high probability that they will collide with each other. Because data scheduling is used for early warning of vehicle collision, the correlation information of the data item transmitted by the vehicle A records that it is relevant to the data item transmitted by the vehicle B, while the correlation information of the data item transmitted by the vehicle B records that it is relevant to the data item transmitted by the vehicle A.

After a data item transmitted by the vehicle A is received in step 301, it is firstly determined in step 302 that the storage 15 already has the data scheduling structure 150 stored therein. In the step 304, all data items transmitted by the vehicle A and the vehicle B are retrieved from the data scheduling structure 150 according to the correlation information of the data item transmitted by the vehicle A, and the retrieved data items are exactly the aforesaid relevant data items. Next in step 305, a weight calculation is performed according to the parameter set of the currently received data item and the parameter sets of the relevant data items to generate a weight calculation result in the step 306. Thereafter, in step 307, the currently received data item is inserted into the data scheduling structure 150 according to the weight calculation result, so as to generate an updated data scheduling structure in the step 308. Finally, in step 309, the updated data scheduling structure is output.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

In summary, according to the present invention, a relevant data item is retrieved from data items of the data scheduling structure according to the input data item, then a weight calculation is performed on the input data item and the relevant data item to generate a weight calculation result, and the weight calculation result is used to update the original data scheduling structure. In other words, by virtue of relevance between data items, the present invention re-performs the weight calculation only on a portion of the data items of the data scheduling structure and updates the original data scheduling structure. This reduces the computational cost needed for the data scheduling and improves the scheduling accuracy, thereby overcoming the drawbacks of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A process apparatus for implementing a data scheduling method, comprising:
a storage, being configured to store a data scheduling structure constructed of a plurality of data items in an execution sequence;
a receiving interface, being configured to receive an input data item; and
a microprocessor, being electrically connected to the storage and the receiving interface respectively and configured to:
retrieve a relevant data item from the data items according to the input data item;
perform a weight calculation according to the relevant data item and the input data item to generate a weight calculation result; and
insert the input data item into the data scheduling structure according to the weight calculation result to generate an updated data scheduling structure.

2. The process apparatus as claimed in claim 1, wherein the microprocessor is further configured to determine that the storage stores the data scheduling structure therein.

3. The process apparatus as claimed in claim 1, wherein each of the input data item and the relevant data item comprises a parameter set respectively, and the microprocessor is configured to perform the weight calculation according to the parameter set of the input data item and the parameter set of the relevant data item to generate the weight calculation result.

4. The process apparatus as claimed in claim 3, wherein the parameter set may comprise an arrival time parameter, a wait time parameter, a distance parameter, a velocity parameter or a combination thereof.

5. The process apparatus as claimed in claim 1, wherein the input data item comprises correlation information, the microprocessor is configured to retrieve the relevant data item from the data items according to the relevant information of the input data item to update the data scheduling structure.

6. The process apparatus as claimed in claim 1, wherein the microprocessor is further configured to output the updated data scheduling structure.

7. A data scheduling method implemented by a process apparatus, the process apparatus comprising a storage, a receiving interface and a microprocessor, the storage being configured to store a data scheduling structure constructed of a plurality of data items in an execution sequence, the receiving interface being configured to receive an input data item, the microprocessor being electrically connected to the storage and the receiving interface respectively, the data scheduling method comprising the following steps of:
(A) enabling the microprocessor to retrieve a relevant data item from the data items according to the input data item;
(B) enabling the microprocessor to perform a weight calculation according to the relevant data item and the input data item to generate a weight calculation result; and
(C) enabling the microprocessor to insert the input data item into the data scheduling structure according to the weight calculation result to generate an updated data scheduling structure.

8. The data scheduling method as claimed in claim 7, wherein the data scheduling method further comprises the following step of:
enabling the microprocessor to determine that the storage stores the data scheduling structure therein.

9. The data scheduling method as claimed in claim 7, wherein each of the input data item and the relevant data item comprises a parameter set respectively, and the data scheduling method further comprises the following step of:
enabling the microprocessor to perform the weight calculation according to the parameter set of the input data item and the parameter set of the relevant data item to generate the weight calculation result.

10. The data scheduling method as claimed in claim 9, wherein the parameter set may comprise an arrival time parameter, a wait time parameter, a distance parameter, a velocity parameter or a combination thereof.

11. The data scheduling method as claimed in claim 7, wherein the input data item comprises correlation information, and the data scheduling method further comprises the following step of:
enabling the microprocessor to retrieve the relevant data item from the data items according to the relevant information of the input data item to update the data scheduling structure.

12. The data scheduling method as claimed in claim 7, further comprising the following step:
enabling the microprocessor to output the updated data scheduling structure.

13. A computer readable medium, storing a program of a data scheduling method for use in a process apparatus, the process apparatus comprising a storage, a receiving interface and a microprocessor, the storage being configured to store a data scheduling structure constructed of a plurality of data items in an execution sequence, the receiving interface being configured to receive an input data item, and the microprocessor being electrically connected to the storage and the receiving interface respectively, and when being loaded into the process apparatus, the program executes:
a code A for enabling the microprocessor to retrieve a relevant data item from the data items according to the input data item;
a code B for enabling the microprocessor to perform a weight calculation according to the relevant data item and the input data item to generate a weight calculation result; and
a code C for enabling the microprocessor to insert the input data item into the data scheduling structure according to the weight calculation result to generate an updated data scheduling structure.

14. The computer readable medium as claimed in claim 13, wherein the program further executes:
a code D for enabling the microprocessor to further determine that the storage stores the data scheduling structure therein.

15. The computer readable medium as claimed in claim 13, wherein each of the input data item and the relevant data item comprises a parameter set respectively, and the program further executes:
a code E for enabling the microprocessor to perform the weight calculation according to the parameter set of the input data item and the parameter set of the relevant data item to generate the weight calculation result.

16. The computer readable medium as claimed in claim 15, wherein the parameter set may comprise an arrival time parameter, a wait time parameter, a distance parameter, a velocity parameter or a combination thereof.

17. The computer readable medium as claimed in claim 13, wherein the input data item comprises correlation information, and the program further executes:
a code F for enabling the microprocessor to retrieve the relevant data item from the data items according to the relevant information according to the input data item to update the data scheduling structure.

18. The computer readable medium as claimed in claim 13, wherein the program further executes:
a code G for enabling the microprocessor to output the updated data scheduling structure.
